(19) United States
(12) Patent Application Publication
(10) Pub. No.: US 2009/0313082 A1
(43) Pub. Date: Dec. 17, 2009

(54) Method and Apparatus for Collecting Information About Targeted Behavior on the Internet

(76) Inventors: Satish Mehta, Fremont, CA (US); Srinivas Margsahayam, San Jose, CA (US)

Correspondence Address: STATTLER - SUH PC, 60 SOUTH MARKET STREET, SUITE 480, SAN JOSE, CA, 95113, US

(21) Appl. No.: 12/137,888

(22) Filed: Jun. 12, 2008

(51) Int. Cl. G06Q 10/00; G06Q 30/00; G06Q 20/00

(52) U.S. Cl. 705/10; 705/80; 705/14.49

(57) ABSTRACT

A method and apparatus are provided for collecting information about targeted behavior on the Internet. In one example, the method includes sending an offer to participate in a tracking program to a user computer, receiving an acceptance of the offer to participate from the user computer, sending a software code device to the user computer, receiving targeted behavior information from the software code device located on the user computer, and sending payment for the targeted behavior information to the user computer.

### FIELD OF THE INVENTION

The present invention relates to tracking user behavior on the Internet. More particularly, the present invention relates to collecting information about targeted behavior on the Internet.

### BACKGROUND OF THE INVENTION

An advertiser, such as Ford® or McDonald's®, generally contracts a creative agency for ads to be placed in various media for the advertiser's products. Such media may include TV, radio, Internet ads (e.g., banner display ads, textual ads, streaming ads, mobile phone ads) or print media ads (e.g., ads in newspapers, magazines and posters). It is quite possible that the advertiser may engage one or more creative agencies that specialize in creating ads for one or more of the above media. A company wants to show the most relevant ads to consumers in order to get the most value from their ad campaign.

A company like Yahoo!® gathers enormous amounts of data related to IP (Internet Protocol) addresses of consumer computers. For example, Yahoo!® sees IP addresses from which Yahoo!® can usually infer zip codes and even street-level data. Yahoo!® sees login information and sees the pages that consumers visit. Yahoo!® can infer age, gender, income and other demographic information from analyzing the pages a consumer visits even if the consumer never does a search. Of course, Yahoo!® also gathers valuable search data when consumers perform search queries. All of this data is highly valuable to any company that advertises because the data may help the company advertise in the most effective way.

The search advertising marketplace generates billions of dollars in revenue each year for a search engine, such as Yahoo!®. The search marketing marketplace works on a cost-per-click (CPC) model. When a consumer performs a search query online and clicks on a sponsored search text ad, the respective advertiser pays a company like Yahoo!®. Consumers tend to click on more relevant ads. It is the company's best interest to show the most relevant ads to consumers, in order to get more clicks on these ads. In order to do this, the company needs to gather information about consumers' search behavior and click behavior. Search behavior is what the consumer searches. Primary evidence for search behavior is the key words used in the consumer search. Click behavior is what the consumer click on the search page after a search. The clicks may include clicking to select an ad, clicking to close an ad, etc. The company can then use this information to target relevant ads to different consumers.

The problem is that there is oftentimes no mechanism in place to determine whether or not the advertiser sent an ad to an appropriately targeted user. User behavior information must be known in order to verify if ads are being targeted appropriately. Currently, any search engine relies primarily on beacon code, which is embedded in a participating advertiser's code and sends signals back to a company like Yahoo!® to track events pertinent to that advertiser. There are other means of tracking user behavior, such as hidden spyware programs that gather information on user behavior. Unfortunately, spyware programs are highly intrusive to the user and, meanwhile, offer little benefit to the user. Users do not want spyware on their computers and typically go through extensive measures to remove spyware. For a behavioral targeting program of a company like Yahoo!® to be successful, it is important that the company has a reliable influx of user behavior information.

### SUMMARY OF THE INVENTION

What is needed is an improved method having features for addressing the problems mentioned above and new features not yet discussed. Broadly speaking, the present invention fills these needs by providing a method and apparatus for collecting information about targeted behavior on the Internet. It should be appreciated that the present invention can be implemented in numerous ways, including as a method, a process, an apparatus, a system or a device. Inventive embodiments of the present invention are summarized below.

In one embodiment, a method is provided for collecting information about targeted behavior on an Internet. The method comprises sending an offer to participate in a tracking program to a user computer, receiving an acceptance of the offer to participate from the user computer, sending a software code device to the user computer, receiving targeted behavior information from the software code device located on the user computer, and sending payment for the targeted behavior information to the user computer.

In another embodiment, a method is provided for tracking targeted behavior on an Internet. The method comprises cleaning out pre-existing spyware type of software loaded on a user computer, tracking user behavior on the Internet to obtain targeted behavior information, and sending the targeted behavior information to a web server.

In still another embodiment, an apparatus is provided for collecting information about targeted behavior on an Internet. The apparatus comprises a communication device configured to send an offer to participate in a tracking program to a user computer, further configured to receive an acceptance of the offer to participate from the user computer, further configured to send a software code device to the user computer, and further configured to receive targeted behavior information from the software code device located on the user computer; and a payment device configured to send payment for the targeted behavior information to the user computer.

In yet another embodiment, an apparatus is provided for tracking targeted behavior on an Internet. The apparatus comprises a cleaning device configured to clean out pre-existing spyware type of software loaded on a user computer; a tracking device configured to track user behavior on the Internet to obtain targeted behavior information; and a communication device configured to send the targeted behavior information to a web server.

In still yet another embodiment, a computer readable medium carrying one or more instructions for collecting information about targeted behavior on an Internet is provided. The one or more instructions, when executed by one or more processors, cause the one or more processors to perform the steps of sending an offer to participate in a tracking program to a user computer, receiving an acceptance of the offer to participate from the user computer, sending a software code device to the user computer, receiving targeted behavior information from the software code device located on the user computer, and sending payment for the targeted behavior information to the user computer.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for collecting information about targeted behavior on the Internet, in accordance with an embodiment of the present invention;

FIG. 2 is a schematic diagram of a system for collecting information about targeted behavior on the Internet, in accordance with an embodiment of the present invention;

FIG. 3 is a flowchart of method of collecting information about targeted behavior on the Internet, in accordance with an embodiment of the present invention; and

FIG. 4 is a flowchart of a method of tracking targeted behavior on the Internet, in accordance with an embodiment of the present invention.

### DETAILED DESCRIPTION OF THE INVENTION

An invention for a method and apparatus for collecting information about targeted behavior on the Internet is disclosed. Numerous specific details are set forth in order to provide a thorough understanding of the present invention. It will be understood, however, to one skilled in the art, that the present invention may be practiced with other specific details.

### General Overview

The system will install a relatively small chunk of software code on the computer of a user who accepts participation in the tracking service of the present invention. The downloaded software code will enable a company like Yahoo® to obtain targeted behavior information related to searches, browsing, emails, videos, music downloading, Internet based games, selling, buying, instant messages, times of usage, behavior of other users of the computer and other behavior. This tracking service is useful to a user because the tracking service pays the user a certain amount of money for targeted behavior information. This information gathering can greatly help a company like Yahoo® to perform better behavior targeting.

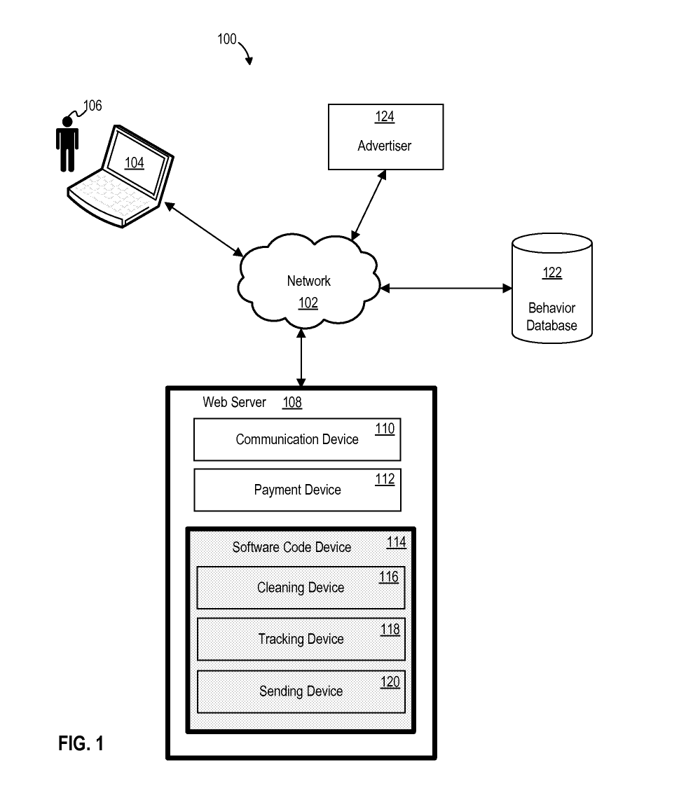

FIG. 1 is a block diagram of a system 100 for collecting information about targeted behavior on the Internet, in accordance with an embodiment of the present invention. A device of the present invention is hardware, software or a combination thereof. A device may sometimes be referred to as an apparatus. Each device is configured to carry out one or more steps of the method of collecting behavior targeting information.

The network 102 couples together a consumer computer 104, a web server 108, a behavior database 122 and an advertiser 124. The network 102 may be any combination of networks including without limitation the Internet, a local area network, a wide area network, a wireless network and a cellular network. The consumer computer 104 is configured to be operated by a user 106. The web server 108 includes without limitation a communication device 110, a payment device 112 and a software code device 114, which is configured to be downloaded to the user computer 104. The software code device 114 includes without limitation a cleaning device 116, a tracking device 118 and a communication device 120.

Alternatively, another apparatus (not shown), other than the web server 108, includes at least one of the communication device 110, the payment device 112 and the software code device 114. The operator of this other apparatus may be, for example, an ISP (Internet service provider), a cyber cafe or other Internet provider.

### Collecting Behavior Information

There are a myriad of conventional programs that install themselves hidden to a user and that are designed to track user behavior information surreptitiously. An example of such a hidden program is spyware, which provides no incentive to users to use the spyware. However, there is value in providing some incentive to a user that provides the system 100 the opportunity to better understand user behavior.

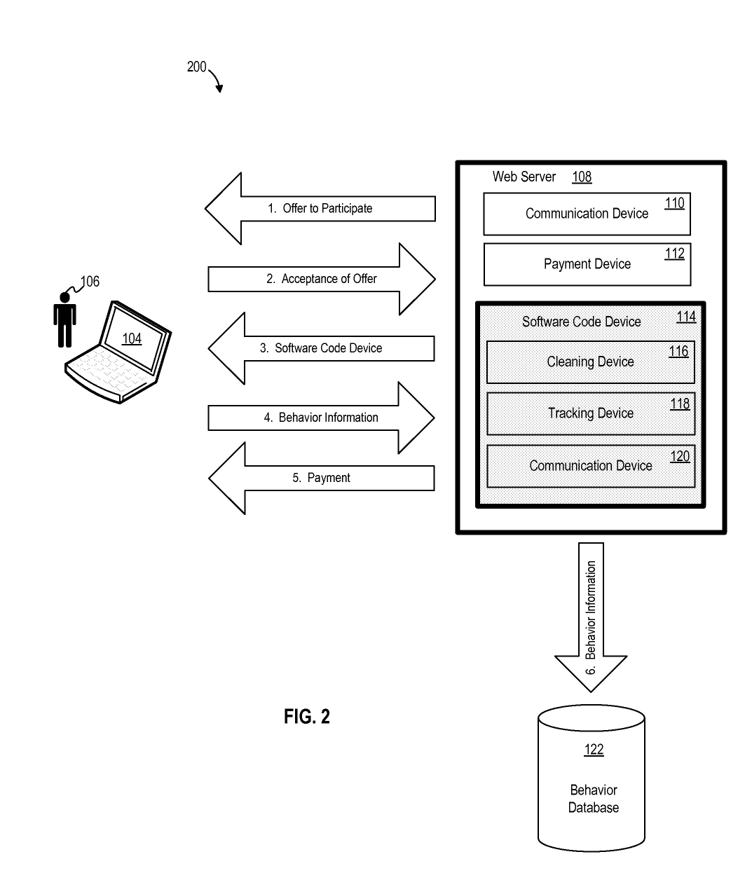

FIG. 2 is a schematic diagram of a system 200 for collecting information about targeted behavior on the Internet, in accordance with an embodiment of the present invention. The web server 108 sends an offer to participate in the tracking service. The offer includes a description of the tracking service and a request for the proper payment method. The description of the tracking service preferably includes a full disclosure of the purpose of the tracking service. The web server 108 needs to know the proper way to send payment to the user. Each user that accepts the offer will provide an account number or other payment method to the web server 108 to enable the web server 108 to pay the user periodically, for example, on a monthly basis. Accordingly, the web server 108 preferably receives from the user computer 104 an acceptance including the desired method of payment.

The web server 108 then provides the software code device 114 to the user computer 104. The software code device 114 is a relatively lightweight software program configured to install itself on the user computer 104. The software code device 114 uninstalls and removes any spyware type of program that is in the user computer 104. The software code device 114 then tracks targeted user behavior. Targeted user behavior includes without limitation web browsing, buying, selling, emailing, instant messaging, video/music downloading, timing of Internet usage, behavior of other users of the user computer 104 and other behavior.

The software code device 114 on the user computer 104 then sends the targeted behavior information to the web server 108. In return for providing the behavior information, the web server 108 sends payment to the user computer 104 using the desired method of payment. Accordingly, the user 106 is compensated appropriately in a predefined manner.

Some arbitrary examples of how the web server 108 compensates the user 106 are given here. Web navigation to 10 different URL yields X cents. Buying or selling yields X cents per transaction. Search behavior yields X cents per 10 searches. Video watching yields X cents per watch session. Music listening yields X cents per 5 .wav files. Emailing yields X cents per 10 emails. Instant messaging yields X cents per 15 minutes of active usage. Other targeted behavior also yields appropriate compensation.

The system 200 provides the user with the option of disabling or removing the software code device 114. For example, the user may decide to disable the software code device 114 when the user is taking part in online banking. The software code device 114 is preferably non-intrusive to the user.

The web server 108 stores the behavior information in some type of database, such as the behavior database 122. The advertiser 124 of FIG. 1 may utilize the information stored in the behavior database 122. The system 200 is a win across the board for all parties involved. The user 106 is compensated appropriately merely for interacting with the Internet in ways the user 106 already does. The web server 108 gets a steady influx of reliable behavior information. The advertiser 124 can better target ads because of the reliable behavior information that the web server 108 has. In turn, the web server 108 can charge the advertiser 124 more for identifying better targeted ads.

A third party, other than the owner of the web server 108, may find the system 200 to be useful. For example, an ISP (Internet service provider), a cyber cafe or other Internet provider may find the system 200 useful. These Internet providers may use the system 200 to send the software cod device 114 to users that utilize their services. The software code device 114 is installed on the user computers and sends behavior information to the web server 108 as before. Accordingly, a base company like Yahoo® can not only monetize its own user base but also monetize the user base of third parties.

### Method Outline

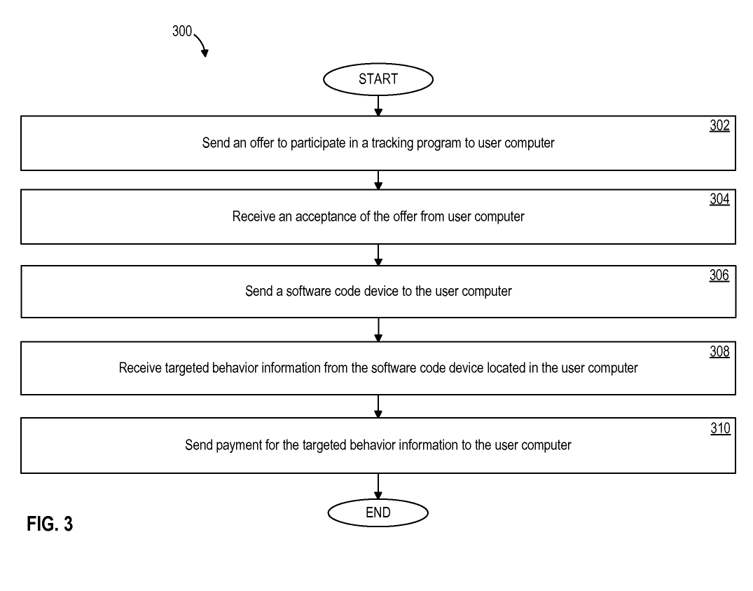

FIG. 3 is a flowchart of method 300 of collecting information about targeted behavior on the Internet, in accordance with an embodiment of the present invention. The web server 108 of FIG. 2 or a similar third party apparatus may be configured to carry out this method 300. The method 300 starts in step 302 where the system sends an offer to participate in this tracking program. The system sends this offer to the user computer. The communication device 110 of FIG. 2 may be configured to carry out this step 302. The method then moves to step 304 where the system receives an acceptance of the offer from the user computer. The communication device 110 of FIG. 2 may be configured to carry out this step 304. Next, in step 306, the system 300 sends a software code device to the user computer. The communication device 110 of FIG. 2 may be configured to carry out this step 306. In step 308, the system 300 then receives targeted behavior information from the software code device located on the user computer. The communication device 110 of FIG. 2 may be configured to carry out this step 308. The method 300 then proceeds to step 310 where the system sends payment for targeted behavior information to the user computer. The payment device 112 of FIG. 2 may be configured to carry out this step 310. The method 300 is then at an end.

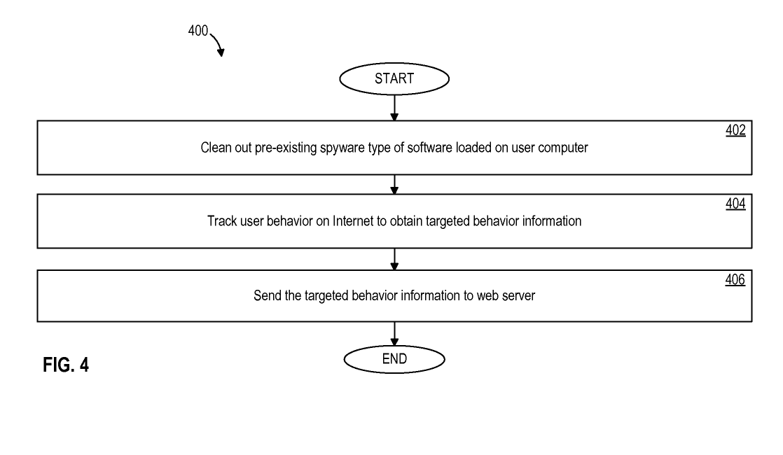

FIG. 4 is a flowchart of a method 400 of tracking targeted behavior on the Internet, in accordance with an embodiment of the present invention. The software code device 114 of FIG. 2 may be configured to carry out this method 400. The method 400 starts in step 402 where the system cleans out pre-existing spyware type software that may be loaded on the user computer. The cleaning device 116 of FIG. 2 may be configured to carry out this step 402. The method 400 then moves to step 404 where the system tracks user behavior on the Internet to obtain targeted behavior information. The tracking device 118 of FIG. 2 may be configured to carry out this step 404. Next, in step 406, the system sends the targeted behavior information to the web server. The communication device 120 may be configured to carry out this step 406. The method 400 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including without limitation sending an offer to participate in a tracking program to a user computer, receiving an acceptance of the offer to participate from the user computer, sending a software code device to the user computer, receiving targeted behavior information from the software code device located on the user computer, and sending payment for the targeted behavior information to the user computer, according to processes of the present invention.

### Advantages

The system of the present invention enables a company like Yahoo® to understand user behavior and user profiles better. This understanding will enable an entity, such as Yahoo® or another Internet provider, to target users substantially more efficiently. Because of the payment scheme to users, the system will indirectly help market a company's services. The payment scheme will cause users to flock to the search engine of a company like Yahoo®. Further, this system uninstalls and frees the host computer of any spyware type of hidden program. A company like Yahoo® can also have third parties, such as ISPs, cyber cafes and other Internet providers, participating in this program. A company like Yahoo® can thereby monetize the user base of these third parties.

With conventional technology that tracks user behavior, users do not receive any payment for providing their valuable behavior information. Accordingly, with proper implementation, the system of the present invention will fill a void in the marketplace and become wildly popular among users.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of collecting information about targeted behavior on an Internet, the method comprising:
sending an offer to participate in a tracking program to a user computer;
receiving an acceptance of the offer to participate from the user computer;
sending a software code device to the user computer;
receiving targeted behavior information from the software code device located on the user computer; and
sending payment for the targeted behavior information to the user computer.

2. The method of claim 1, wherein the receiving the acceptance of the offer includes the proper method to send the payment to the user.

3. The method of claim 1, wherein the targeted behavior information includes information about Internet activity in at least one of:
web browsing;
buying;
selling;
emailing;
instant messaging;
video viewing;
music listening;
timing of Internet usage; and
behavior of other users of the user computer.

4. The method of claim 1, wherein the payment is appropriate compensation for targeted behavior that is valuable to an advertiser, and wherein the method further comprises identifying better targeted ads for the advertiser.

5. The method of claim 1, wherein the software code device is configured to track user behavior on the Internet, and wherein the sending the offer to participate further comprises sending a full disclosure of a purpose of the tracking service.

6. A method for tracking targeted behavior on an Internet, the method comprising:
cleaning out pre-existing spyware type of software loaded on a user computer;
tracking user behavior on the Internet to obtain targeted behavior information; and
sending the targeted behavior information to a web server.

7. The method of claim 6, wherein the tracking user behavior comprises tracking Internet activity in at least one of:
web browsing;
buying;
selling;
emailing;
instant messaging;
video viewing;
music listening;
timing of Internet usage; and
behavior of other users of the user computer.

8. The method of claim 6, further comprising self-installing a software code device onto the user computer, wherein the software code device is configured to carry out the cleaning, the tracking and the sending.

9. The method of claim 8, further comprising:
receiving a request to disable the software code device; and
self-disabling the software code device.

10. The method of claim 8, further comprising:
receiving a request to remove the software code device; and
self-removing the software code device from the user computer.

11. An apparatus for collecting information about targeted behavior on an Internet, the apparatus comprising:
a communication device configured to send an offer to participate in a tracking program to a user computer, further configured to receive an acceptance of the offer to participate from the user computer, further configured to send a software code device to the user computer, and further configured to receive targeted behavior information from the software code device located on the user computer; and
a payment device configured to send payment for the targeted behavior information to the user computer.

12. The apparatus of claim 11, wherein the communication device is further configured to receive the proper method to send the payment to the user.

13. The apparatus of claim 11, wherein the targeted behavior information includes information about Internet activity in at least one of:
web browsing;
buying;
selling;
emailing;
instant messaging;
video viewing;
music listening;
timing of Internet usage; and
behavior of other users of the user computer.

14. The apparatus of claim 11, wherein the payment is appropriate compensation for targeted behavior that is valuable to an advertiser, and wherein the apparatus is further configured to identify better targeted ads for the advertiser.

15. The apparatus of claim 11, wherein the software code device is configured to track user behavior on the Internet, and wherein the communication device is further configured to send a full disclosure of a purpose of the tracking service.

16. An apparatus for tracking targeted behavior on an Internet, the apparatus comprising:
a cleaning device configured to clean out pre-existing spyware type of software loaded on a user computer;
a tracking device configured to track user behavior on the Internet to obtain targeted behavior information; and
a communication device configured to send the targeted behavior information to a web server.

17. The apparatus of claim 16, wherein the tracking device is further configured to track Internet activity in at least one of:
web browsing;
buying;
selling;
emailing;
instant messaging;
video viewing;
music listening;
timing of Internet usage; and
behavior of other users of the user computer.

18. The apparatus of claim 16, wherein the apparatus is further configured to self-install a software code device onto the user computer, wherein the software code device includes the cleaning device, the tracking device and the communication device.

19. The apparatus of claim 18, wherein the software code device is further configured to receive a request to disable the software code device, and further configured to self-disable the software code device.

20. The apparatus of claim 18, wherein the software coded device is further configured to receive a request to remove the software code device, and further configured to self-removing the software code device from the user computer.

21. A computer readable medium carrying one or more instructions for collecting information about targeted behavior on an Internet, wherein the one or more instructions, when executed by one or more processors, cause the one or more processors to perform the steps of:
sending an offer to participate in a tracking program to a user computer;
receiving an acceptance of the offer to participate from the user computer;
sending a software code device to the user computer;
receiving targeted behavior information from the software code device located on the user computer; and
sending payment for the targeted behavior information to the user computer.
